(19) United States
(12) Patent Application Publication
(10) Pub. No.: US 2024/0360268 A1
(43) Pub. Date: Oct. 31, 2024

(54) RIGID POLYURETHANE FOAMS BASED ON FATTY-ACID-MODIFIED POLYETHER POLYOLS AND CROSSLINKING POLYESTER POLYOLS

(71) Applicant: BASF SE, Ludwigshafen am Rhein (DE)

(72) Inventors: Tobias KALUSCHKE, Lemfoerde (DE); Olaf JACOBMEIER, Lemfoerde (DE); Sebastian KOCH, Lemfoerde (DE)

(21) Appl. No.: 18/571,975

(22) PCT Filed: Jul. 14, 2022
(86) PCT No.: PCT/EP2022/069758

§ 371 Date: Dec. 19, 2023

(30) Foreign Application Priority Data
Jul. 21, 2021 (EP) 21186950.8

(51) Int. Cl. C08G 18/40; C08G 18/16; C08G 18/18; C08G 18/22; C08G 18/42; C08G 18/48; C08G 18/76; C08J 9/14; C08K 5/521

(52) U.S. Cl. CPC C08G 18/4018; C08G 18/163; C08G 18/1833; C08G 18/225; C08G 18/4236; C08G 18/4804; C08G 18/4825; C08G 18/4891; C08G 18/7671; C08J 9/141; C08K 5/521; C08G 2110/0025; C08J 2203/14; C08J 2203/182; C08J 2205/10; C08J 2375/08

(57) ABSTRACT

Disclosed herein is a method for preparing rigid polyurethane foams, in which method (a) polyisocyanates are mixed with (b) compounds having at least two hydrogen atoms that are reactive with isocyanate groups, (c) optionally a flame retardant, (d) a blowing agent, (e) a catalyst, and (f) optionally auxiliary agents and additives, to form a reaction mixture and are cured to provide the rigid polyurethane foam. Further disclosed herein are a rigid polyurethane foam obtained by the method and a method of using the rigid polyurethane foam in the manufacture of sandwich elements.

The present invention relates to a process for producing rigid polyurethane foams in which (a) polyisocyanates are mixed with (b) compounds having at least two hydrogen atoms reactive toward isocyanate groups, (c) optionally flame retardant, (d) blowing agent, (e) catalyst, and (f) optionally auxiliaries and additives to give a reaction mixture and cured to form a rigid polyurethane foam. wherein component (b) comprises at least one polyether polyol (b1) prepared by reaction of 15% to 40% by weight, based on the total weight of the polyether polyol (b1), of one or more polyols or polyamines (b11) having an average functionality of 2.5 to 8, 2% to 30% by weight, based on the total weight of the polyether polyol (b1), of one or more fatty acids and/or fatty acid monoesters (b12), and 35% to 70% by weight, based on the total weight of the polyether polyol (b1), of propylene oxide (b13), and at least 20% by weight, based on the total weight of component (b), of polyester polyol (b2) having an average functionality of 2.4 or greater hand an OH value of 280 mg KOH/g or more and optionally one or more amine-started polyether polyols (b3), one or more highly functional polyether polyols (b4) having an average functionality of at least 5.0, and also one or more chain extenders and/or crosslinkers (b5), and wherein component (b) in addition to components (b1) to (b5) comprises less than 20% by weight, based on the total weight of component (b), of further compounds having at least two hydrogen atoms reactive toward isocyanate groups. The present invention further relates to a rigid polyurethane foam obtainable by such a process and to the use of a rigid polyurethane foam of the invention for the production of sandwich elements.

Numerous publications in the patent literature and other literature describe the production of rigid polyurethane foams through the reaction of polyisocyanates with relatively high-molecular-weight compounds having at least two reactive hydrogen atoms, in particular with polyether polyols from alkylene oxide polymerization or with polyester polyols from the polycondensation of alcohols with dicarboxylic acids, in the presence of polyurethane catalysts, chain extenders and/or crosslinkers, blowing agents, and further auxiliaries and additives.

Rigid polyurethane foams are commonly used as insulation material for thermal insulation. The foams are used for example in the production of refrigerators, containers or flat composite elements having at least one outer layer. These require rigid polyurethane foams having high mechanical strength, low thermal conductivity, high fire resistance, and a surface that is as defect-free as possible.

In the construction sector in particular, for example for composite elements composed of metallic outer layers and a polyurethane core, it is particularly important that the rigid polyurethane foams have good flame-retardancy. For this reason, rigid polyisocyanurate foams have been developed that have improved flame resistance compared to rigid polyurethane foams and allow the proportions of flame retardants in the reaction component to be substantially reduced. A rigid polyisocyanurate foam is usually understood as meaning a foam that contains not only urethane groups but also isocyanurate groups. In the context of the invention, the term rigid polyurethane foam is also intended to encompass rigid polyisocyanurate foam, polyisocyanurate foams being produced when working at isocyanate indexes of greater than 180. A major problem associated with the rigid polyisocyanurate foams currently known from the prior art is inadequate adhesion of the foam to the metallic outer layers. To remedy this shortcoming, an adhesion promoter is usually applied between the outer layer and the foam, as described for example in EP1516720. In addition, the processing of rigid polyisocyanurate foams usually requires a high mold temperature of >60° C. in order to ensure sufficient trimerization of the polyisocyanate component, which results in a higher crosslinking density and thus in better thermal stabilities, compressive strengths, and flame resistances in the foam. Both increasing the mold temperature and applying an adhesion promoter increase complexity and reduce the cost-effectiveness of component production, which is why both measures are undesirable from a production and economic viewpoint.

Compared to rigid polyisocyanurate foams, rigid polyurethane foams usually display significantly better adhesion of the foam to the metallic outer layers and can be reacted at significantly lower processing temperatures.

Flame-retardant rigid polyurethane foams processed at an isocyanate index of 160 and less and that pass the vertical flame test according to DIN EN ISO 11925-2 usually comprise a significantly higher proportion of liquid halogenated flame retardants.

EP0757068 B1 describes, for example, a process for producing rigid polyurethane foams, in the production of which large amounts of chlorine compounds, bromine compounds, and phosphorus compounds are used in the polyol component. However, for ecotoxicological reasons and because of improved secondary burning phenomena, it is desirable to keep the use of halogenated flame retardants, in particular brominated flame retardants, in the polyol component as low as possible. The use of halogen-free flame retardants usually results in a worsening in the mechanical properties of the foam, since common liquid halogen-free flame retardants usually have softening properties and, because of their reduced gas-phase activity, often have to be used in significantly larger proportions in polyol components for rigid polyurethane foams in order to obtain comparable flame resistances in the foam.

EP2561002 B1 describes the composition of a polyol component comprising a fatty-acid-based aromatic polyester polyol and a polyether polyol having a functionality of 4-8 and a hydroxyl value of 300-600 mg KOH/g. The reaction of this polyol component at average isocyanate indices in the range from 170 to 230 at processing temperatures between 40 and 50° C. allows a significant saving in flame retardants compared to conventional flame-retardant rigid PUR foams. However, these PUR/PIR hybrid systems have significantly poorer curing behavior, which can lead to the formation of corrugations during the production of composite elements. The processing especially of thin sandwich elements having thicknesses of less than 60 mm often leads to problems in the curing, adhesion to outer layers, and flame resistance of the rigid foam on account of the low heat evolution in the reaction mixture.

EP 3619250 shows that the use of special polyol components having a high proportion of aromatic Mannich polyols in combination with special silicone stabilizers permits large savings in the amounts of flame retardant. However, the high amount of Mannich polyol and further amine polyol required for this purpose results in the development of very high temperatures in the curing reaction mixture, which in the continuous production of sandwich elements leads to a significantly greater element thickness in the middle of the panel and thus to poorer planarity in the elements produced. In the discontinuous production of components, a longer demolding time is necessary, which is why the use of high proportions of reactive aromatic Mannich polyols is undesirable.

Unfortunately, the use of the foam stabilizers described in EP 3619250 also often results in insufficient foam stabilization, which is why improving the foam surfaces and reducing average cell sizes is desirable, especially when using silicone-containing foam stabilizers, which have a beneficial effect in the flame test according to DIN EN ISO 11925-2.

A general problem with rigid polyurethane foams is also the formation of surface defects, especially at the interface with the outer layers. Such foam surface defects result in the formation of an uneven outer surface, thereby leading to visible blemishes and increased thermal conductivity in the polyurethane-based components.

It was accordingly an object of the present invention to improve the property profile of known rigid polyurethane foams. In particular, it was an object of the present invention to provide a rigid polyurethane foam having excellent flame resistance, excellent mechanical properties, such as compressive strength and brittleness, excellent thermal conductivity, and excellent surface quality. A further object was to provide a process for producing such a rigid polyurethane foam that permits rapid curing of the reaction mixture to a foam even at mold temperatures of less than 60° C., in particular 50° C. or less, and displays good adhesion to outer layers, for example in the production of sandwich elements.

This object is achieved by a process for producing rigid polyurethane foams in which (a) polyisocyanates are mixed with (b) compounds having at least two hydrogen atoms reactive toward isocyanate groups, (c) optionally flame retardant, (d) blowing agent, (e) catalyst, and (f) optionally auxiliaries and additives to give a reaction mixture and cured to form a rigid polyurethane foam, wherein component (b) comprises at least one polyether polyol (b1) prepared by reaction of 15% to 40% by weight, based on the total weight of the polyether polyol (b1), of one or more polyols or polyamines (b11) having an average functionality of 2.5 to 8, 2% to 30% by weight, based on the total weight of the polyether polyol (b1), of one or more fatty acids and/or fatty acid monoesters (b12), and 35% to 70% by weight, based on the total weight of the polyether polyol (b1), of propylene oxide (b13), and wherein at least 20% by weight, based on the total weight of component (b), of polyester polyol (b2) having an average functionality of 2.4 or greater and an OH value of 280 mg KOH/g or more and optionally one or more amine-started polyether polyols (b3), one or more highly functional polyether polyols (b4) having an average functionality of at least 5.0, and also one or more chain extenders and/or crosslinkers (b5), and component (b) in addition to components (b1) to (b5) comprises less than 20% by weight, based on the total weight of component (b), of further compounds having at least two hydrogen atoms reactive toward isocyanate groups. The present invention further relates to a rigid polyurethane foam obtainable by such a process and to the use of a rigid polyurethane foam of the invention for the production of sandwich elements. In the context of the invention, a rigid polyurethane foam is understood as meaning a foamed polyurethane, preferably a foam in accordance with DIN 7726, that has a compressive strength according to DIN 53 421/DIN EN ISO 604 of greater than or equal to 80 kPa, preferably greater than or equal to 150 kPa, more preferably greater than or equal to 180 kPa. In addition, the rigid polyurethane foam has a closed-cell content according to DIN ISO 4590 of greater than 50%, preferably greater than 85%, and more preferably greater than 90%.

Useful polyisocyanates (a) are the aliphatic, cycloaliphatic, araliphatic, and preferably aromatic polyfunctional isocyanates known per se. Such polyfunctional isocyanates are known per se or can be prepared by methods known per se. The polyfunctional isocyanates may in particular also be used in the form of mixtures, so that component (a) in this case comprises different polyfunctional isocyanates. Polyfunctional isocyanates useful as polyisocyanate have two isocyanate groups per molecule (these are hereinafter referred to as diisocyanates) or more than two.

These include, in particular: alkylene diisocyanates having 4 to 12 carbon atoms in the alkylene radical, such as dodecane 1,12-diisocyanate, 2-ethyltetramethylene 1,4-diisocyanate, 2-methylpentamethylene 1,5-diisocyanate, tetramethylene 1,4-diisocyanate, and preferably hexamethylene 1,6-diisocyanate; cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (IPDI), hexahydrotolylene 2,4- and 2,6-diisocyanate, and the corresponding isomer mixtures, dicyclohexylmethane 4,4′-, 2,2′-, and 2,4′-diisocyanate, and the corresponding isomer mixtures, and preferably aromatic polyisocyanates, such as tolylene 2,4- and 2,6-diisocyanate and the corresponding isomer mixtures (TDI), diphenylmethane 4,4′-, 2,4′-, and 2,2′-diisocyanate and diphenylmethane diisocyanate homologs having additional rings and the corresponding mixtures (MDI), mixtures of diphenylmethane 4,4′-, 2,4′-, and 2,2′-diisocyanates and polyphenylpolymethylene polyisocyanates (polymer MDI), and mixtures of MDI and TDI.

Particularly suitable polyisocyanates are diphenylmethane 2,2′-, 2,4′-, and/or 4,4′-diisocyanate and diphenylmethane diisocyanate homologs having additional rings (MDI), naphthylene 1,5-diisocyanate (NDI), tolylene 2,4- and/or 2,6-diisocyanate (TDI), 3,3′-dimethyldiphenyl diisocyanate, 1,2-diphenylethane diisocyanate and/or p-phenylene diisocyanate (PPDI), trimethylene, tetramethylene, pentamethylene, hexamethylene, heptamethylene and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate and dicyclohexylmethane 4,4′-, 2,4′- and/or 2,2′-diisocyanate.

Use is frequently also made of modified polyisocyanates, i.e. products that are obtained by chemical reaction of organic polyisocyanates and have at least two reactive isocyanate groups per molecule. Particular mention may be made of polyisocyanates containing ester, urea, biuret, allophanate, carbodiimide, isocyanurate, uretdione, carbamate and/or urethane groups, frequently also together with unreacted polyisocyanates.

The polyisocyanates of component (a) particularly preferably comprise 2,2′-MDI or 2,4′-MDI or 4,4′-MDI (also referred to as monomeric diphenyl methane or MMDI) or oligomeric MDI, which consists of MDI homologs having additional rings that have a total of at least 3 aromatic rings and a functionality of at least 3, or mixtures of at least two of these isomers, optionally also mixtures of at least one MDI isomer with at least one MDI oligomer having additional rings, or crude MDI obtained in MDI production, or preferably mixtures of at least one MDI oligomer having additional rings and at least one of the abovementioned low-molecular-weight MDI derivatives 2,2′-MDI, 2,4′-MDI or 4,4′-MDI (also referred to as polymeric MDI). The MDI isomers and homologs are usually obtained by distillation of crude MDI.

Particular preference is given to using polymeric MDI as isocyanate (a). The average functionality of a polymeric MDI varies preferably in the range of from 2.2 to 4, more preferably from 2.4 to 3.8, and in particular from 2.6 to 3.0. Polymeric MDI is for example marketed by BASF Polyurethanes GmbH under the name Lupranat® M20 or Lupranat® M50.

Component (a) preferably comprises at least 70% by weight, more preferably at least 90% by weight, and in particular 100% by weight, based on the total weight of component (a), of one or more isocyanates selected from the group consisting of 2,2′-MDI, 2,4′-MDI, 4,4′-MDI, and MDI oligomers. The content of oligomeric MDI is here preferably at least 20% by weight, more preferably from more than 30% by weight to less than 80% by weight, based on the total weight of component (a).

The viscosity of the component (a) used may vary within a wide range. Component (a) preferably has a viscosity at 25° C. of from 100 to 3000 mPa·s, more preferably from 100 to 1000 mPa·s, in particular from 100 to 600 mPa·s, especially from 200 to 600 mPa·s, and more especially from 400 to 600 mPa·s.

The compounds having at least two hydrogen atoms reactive toward isocyanate groups (b) comprise at least one fatty-acid-based polyether polyol (b1) and at least one polyester polyol (b2), the proportion by weight of the polyester polyol (b2) being at least 20% by weight based on the total weight of component (b).

The fatty-acid-based polyether (b1) can be produced by reacting from 15% to 40% by weight, based on the total weight of the polyether polyol (b1), of one or more polyols or polyamines (b11) having an average functionality of 2.5 to 8, 2% to 30% by weight, based on the total weight of the polyether polyol (b1), of one or more fatty acids and/or fatty acid monoesters (b12), and 35% to 70% by weight, based on the total weight of the fatty-acid-based polyether polyol (b1), of propylene oxide (b13).

The polyetherols (b1) are prepared according to known methods, for example by anionic polymerization of alkylene oxides comprising propylene oxide (b13), with the addition as a starter molecule of at least one polyalcohol (b11) that contains 2 to 8, preferably 2 to 6, attached reactive hydrogen atoms, and one or more fatty acids and/or fatty acid monoesters (b12) as costarter, in the presence of catalysts. The proportion of the polyalcohol (b11) is here 15% to 40% by weight, preferably 18% to 35% by weight, and in particular 20% to 30% by weight, that of the costarter is 2% to 30% by weight, preferably 3% to 25% by weight, and in particular 5% to 20% by weight, in each case based on the total weight of the polyetherol (b1).

The average (nominal) functionality of the starter molecules (b11) and (b12) is here at least 2.5, preferably 2.6 to 8, more preferably 2.7 to 6.5, and in particular 3 to 6. In the context of the present application, the average functionality is the average nominal functionality of the polyetherols. This refers to the functionality of the starter molecules. If using mixtures of starter molecules having different functionality, fractional functionalities may be obtained. Influences on functionality due for example to side reactions are not taken into account in the nominal functionality.

As catalysts, it is possible to use alkali metal hydroxides, such as sodium hydroxide or potassium hydroxide, or alkali metal alkoxides, such as sodium methoxide, sodium ethoxide, potassium ethoxide or potassium isopropoxide, or in the case of cationic polymerization it is possible to use Lewis acids such as antimony pentachloride, boron trifluoride etherate or fuller's earth as catalysts. It is also possible to use amine-type alkoxylation catalysts, for example dimethylethanolamine (DMEOA), imidazole, and imidazole derivatives. Employable catalysts also include double-metal cyanide compounds, so-called DMC catalysts.

The alkylene oxide used is propylene oxide (b13), optionally together with further alkylene oxides. Employed further alkylene oxides are preferably one or more compounds having 2 to 4 carbon atoms in the alkylene radical, for example tetrahydrofuran, 1,2-propylene oxide, ethylene oxide, or 1,2- or 2,3-butylene oxide, in each case alone or in the form of mixtures. Preference is given to using ethylene oxide and/or 1,2-propylene oxide, especially exclusively 1,2-propylene oxide. The proportion of propylene oxide based on the total weight of the polyether polyol (b1) is 35% to 70% by weight, preferably 40% to 65% by weight.

Useful polyalcohols (b11) are compounds containing hydroxyl groups or amine groups, for example ethylene glycol, diethylene glycol, glycerol, trimethylolpropane, pentaerythritol, sugar derivatives such as sucrose, hexitol derivatives such as sorbitol, methylamine, ethylamine, isopropylamine, butylamine, benzylamine, aniline, toluidine, toluenediamine (TDA), naphthylamine, ethylenediamine, diethylenetriamine, 4,4′-methylenedianiline, propane-1,3-diamine, hexane-1,6-diamine, ethanolamine, diethanolamine, triethanolamine, and also other dihydric or polyhydric alcohols or monofunctional or polyfunctional amines. Since these highly functional compounds are present in solid form under the usual reaction conditions of alkoxylation, it is generally customary to alkoxylate them in a mixture with further initiators. Examples of such suitable further initiators include water, lower polyhydric alcohols, for example glycerol, trimethylolpropane, pentaerythritol, diethylene glycol, ethylene glycol, propylene glycol, and homologs thereof.

Examples of useful further initiators (b12) include organic fatty acids, fatty acid monoesters, and fatty acid methyl esters, for example oleic acid, stearic acid, methyl oleate, methyl stearate or biodiesel; these serve to improve blowing agent solubility in the production of rigid polyurethane foams. Here, it is essential to the invention that the average functionality of the starter molecules (b11 and b12) is at least 2.5.

Preferred polyols (b11) for the production of the polyether polyols (b1) are sorbitol, sucrose, ethylenediamine, TDA, trimethylolpropane, pentaerythritol, glycerol, and diethylene glycol. Particularly preferred starter molecules are sucrose, glycerol, TDA and ethylenediamine, in particular sucrose and/or glycerol. In a particularly preferred embodiment, a mixture comprising sucrose and/or glycerol, in particular a mixture of glycerol and sucrose, are used as the polyols (b11).

The fatty-acid-based polyether polyols used in component (b1) preferably have a functionality of 2.5 to 8, particularly preferably 2.8 to 7, more preferably 3 to 6, and in particular from 3.5 to 5.5 and number-average molecular weights of preferably 100 to 1200, more preferably from 150 to 800, and in particular from 250 to 600. The OH value of the polyether polyols of component (b1) is preferably from 1200 to 100 mg KOH/g, preferably from 1000 to 200 mg KOH/g, and in particular from 800 to 350 mg KOH/g.

According to the invention, component (b) comprises at least 20% by weight, preferably at least 30% by weight, and in particular at least 40% by weight, of one or more polyester polyols (b2) having an average functionality of 2.4 or greater, preferably 2.4 to 8, more preferably 2.4 to 5, and an OH value of 280 mg KOH/g or more, preferably 290 to 500 mg KOH/g, and in particular 300 to 400 mg KOH/g. Suitable polyester polyols (b2) can be obtained by reaction of polycarboxylic acids, in particular of dicarboxylic acids, and polyhydric alcohols, with the alcohol component used in excess. Polycarboxylic acids used may be aliphatic polycarboxylic acids, aromatic polycarboxylic acids or mixtures thereof as well as their derivatives. The functionalities of the starting substances are chosen such that a polyester polyol having a functionality of at least 2.4 is obtained. Carboxylic acid derivatives used may for example be monomeric, dimeric, oligomeric or polymeric polycarboxylic esters of alcohols having 1 to 4 carbon atoms or polycarboxylic anhydrides. Polycarboxylic acids also include functionalized carboxylic acids, such as hydroxycarboxylic acids.

In a particularly preferred embodiment, at least one aromatic polyester polyol (b2a) is used as the polyester polyol (b2). The aromatic polyester polyol (b2a) comprises at least 50 mol %, preferably at least 80 mol %, and in particular 100 mol %, of the parent acid component (aromatic polycarboxylic acids). The term “parent acid component” encompasses polycarboxylic acids and derivatives thereof, such as anhydrides and esters. Aromatic polyester polyols (b2a) preferably have a functionality of 2.4 to 3.5, more preferably 2.4 to 3.0, and in particular 2.45 to 2.8 and an OH value of 280 to 330 mg KOH/g and more preferably 290 to 320 mg KOH/g.

In a further preferred embodiment, at least one aliphatic polyester polyol (b2b) is used as the polyester polyol (b2). The aliphatic polyester polyol (b2b) comprises at least 50 mol %, preferably at least 80 mol %, and in particular 100 mol %, of the parent acid component (aliphatic polycarboxylic acids). Aliphatic polyester polyols (b2b) preferably have a functionality of 2.4 to 4.5, more preferably of more than 2.8 to 4.0, and in particular of more than 3.0 to 3.5, and an OH value of 300 to 400 mg KOH/g and more preferably 340 to 380 mg KOH/g.

Aromatic polyester polyols (b2a) and aliphatic polyester polyols (b2b) may be used together, but it is preferable to use either aromatic polyester polyols (b2a) or aliphatic polyester polyols (b2b).

Polycarboxylic acids include dicarboxylic acids and more highly functional carboxylic acids, such as tricarboxylic acids. Aliphatic dicarboxylic acids or aliphatic dicarboxylic acid derivatives used are preferably adipic acid, glutaric acid, succinic acid, fumaric acid, malonic acid, maleic acid, oxalic acid, pimelic acid, suberic acid, azelaic acid, sebacic acid or derivatives thereof. Examples of derivatives of aliphatic polycarboxylic acids are dimethyl adipate, and diethyl adipate. Particular preference is given to using adipic acid, glutaric acid or succinic acid or derivatives thereof, most preferably adipic acid or derivatives of adipic acid.

Preferred aliphatic functionalized carboxylic acids are hydroxycarboxylic acids, aminocarboxylic acids, halocarboxylic acids, aldehydecarboxylic acids or ketocarboxylic acids. Preference is given to using hydroxycarboxylic acids, such as 6-hydroxyhexanoic acid, or ketocarboxylic acids. It is preferable that exclusively functionalized polycarboxylic acids are used for the production of the aliphatic polyester polyol (b2b), i.e. the aromatic polyester polyols (b1a) preferably do not comprise residual amounts of functionalized carboxylic acids.

As aromatic dicarboxylic acids or as aromatic dicarboxylic acid derivatives, preference is given to using phthalic acid, phthalic anhydride, terephthalic acid and/or isophthalic acid or derivatives thereof, such as dimethyl terephthalate, diethyl terephthalate, dimethyl phthalate, diethyl phthalate, oligomeric or polymeric ethylene terephthalate, and also recyclates thereof, and oligomeric or polymeric butylene terephthalate and also recyclates thereof, in a mixture or alone, preference being given to using phthalic acid, phthalic anhydride, and terephthalic acid. Particular preference is given to using terephthalic acid or dimethyl terephthalate, especially terephthalic acid.

In addition to aliphatic and/or aromatic polycarboxylic acids and/or functionalized aliphatic carboxylic acids, it is also possible to use monofunctional carboxylic acids or reaction products of monofunctional carboxylic acids. Monofunctional carboxylic acids used may be, for example, saturated or unsaturated monocarboxylic acids having 1 to 24 carbon atoms. Examples are formic acid, acetic acid, propionic acid, acrylic acid, butyric acid, valeric acid, caproic acid, benzoic acid, heptanoic acid, caprylic acid, nonanoic acid, capric acid, and fatty acids, for example lauric acid, myristic acid, palmitic acid, stearic acid, oleic acid, ricinoleic acid, linoleic acid, and linolenic acid.

As reaction products of monofunctional carboxylic acids it is also possible to use biobased input materials and/or derivatives thereof, such as castor oil, polyhydroxy fatty acids, hydroxyl-modified oils, grape seed oil, black cumin oil, pumpkin seed oil, borage seed oil, soybean oil, wheat seed oil, rapeseed oil, sunflower seed oil, peanut oil, apricot kernel oil, pistachio oil, almond oil, olive oil, macadamia nut oil, avocado oil, sea buckthorn oil, sesame oil, hemp oil, hazelnut oil, evening primrose oil, wild rose oil, safflower oil, walnut oil, and fatty acid esters based on myristoleic acid, palmitoleic acid, oleic acid, vaccenic acid, petroselic acid, gadoleic acid, erucic acid, nervonic acid, linoleic acid, o- and y-linolenic acid, stearidonic acid, arachidonic acid, timnodonic acid, clupanodonic acid and cervonic acid.

Where monofunctional carboxylic acids or derivatives thereof are used in the preparation of the polyester polyols (b2), this is preferably in amounts such that the polyester polyol (b2), based on the total weight thereof, comprises ≤5% by weight, in particular ≤2.5% by weight, of fatty acid moieties and especially none at all.

Examples of polyhydric alcohols are: ethanediol, diethylene glycol, propane-1,2-diol and-1,3-diol, dipropylene glycol, butane-1,4-diol, pentane-1,5-diol, hexane-1,6-diol, decane-1,10-diol, glycerol, trimethylolpropane, and pentaerythritol, and alkoxides thereof. Preference is given to using ethylene glycol, diethylene glycol, propylene glycol, glycerol, trimethylolpropane or alkoxides thereof or mixtures of at least two of the recited polyhydric alcohols, in particular diethylene glycol and/or glycerol.

In a specific embodiment, an aromatic polyester polyol (b2a) is used that is a polyester polyol having a content of benzene-1,2-, -1,3-, and 1,4-dicarboxylic acid moieties in the polyesterol (b2) of at least 30% by weight, preferably 35% to 75% by weight, more preferably 40% to 70% by weight and in particular 45% to 65% by weight, in each case based on the total weight of the polyester polyol (b2). The high aromatics content has a beneficial effect here on the fire resistance.

In a further specific embodiment, an aliphatic polyester polyol (b2b) is used that is an aliphatic polyester polyol produced using a mixture of waste materials formed in the oxidation of cyclohexane to cyclohexanol and cyclohexanone and carboxylic acids, such as adipic acid, 6-hydroxycapronic acid, valeric acid, butyric acid, acetic acid, caproic acid, formic acid, succinic acid, propionic acid, isovaleric acid, and water and further substances, such as oligomers, keto acids, cyclohexanone dimers or tar substances. The preparation of such esters is described for example in U.S. Pat. No. 9,982,089 B2.

Particularly preferably, the condensation of the aliphatic polyester polyol (b2b) is accomplished by condensation of a mixture comprising 20% to 27% by weight of adipic acid, 10% to 15% by weight of 6-hydroxycaproic acid, 10% to 13% by weight of valeric acid, 20% to 45% by weight of butyric acid, 2% to 3% by weight of acetic acid, 1% to 3% by weight of caproic acid, up to 1.5% by weight of formic acid, up to 1% by weight of succinic acid, up to 1% by weight of propionic acid, up to 0.5% by weight of isovaleric acid, and approx. 10% to 22% by weight of water, and also up to 25% of substances not further identified, such as oligomers, keto acids, cyclohexanone dimers, or tar.

The high aliphatics content has a beneficial effect on foam quality and processability. In addition, the use of such polyester polyols allows the proportion of recycled material in the resulting rigid foam to be increased.

The preparation of the polyester polyols (b2) is known. For the preparation of the polyester polyols (b2), the aliphatic and/or aromatic polycarboxylic acids or derivatives thereof and, if present, the monocarboxylic acids and/or derivatives thereof and/or the functionalized carboxylic acids and/or derivatives thereof can undergo polycondensation with the polyhydric alcohols in the absence of a catalyst or preferably in the presence of esterification catalysts, expediently in an atmosphere of inert gas such as nitrogen in the melt at temperatures of 150 to 280° C., preferably 180 to 260° C., optionally under reduced pressure, to the desired acid value, which is advantageously less than 10, preferably less than 2. In a preferred embodiment, the esterification mixture undergoes polycondensation at the abovementioned temperatures to an acid value of 80 to 20, preferably 40 to 20, at atmospheric pressure and then at a pressure of less than 500 mbar, preferably 40 to 400 mbar. Examples of suitable esterification catalysts are iron, cadmium, cobalt, lead, zinc, antimony, magnesium, titanium, and tin catalysts in the form of metals, metal oxides or metal salts. The polycondensation can, however, also be carried out in the liquid phase in the presence of diluents and/or entraining agents, for example benzene, toluene, xylene or chlorobenzene, for azeotropic removal by distillation of the water of condensation.

In addition to the fatty-acid-based polyether polyol (b1) and the polyester polyol (b2), the compounds having at least two hydrogen atoms (b) reactive toward isocyanate groups may comprise amine-started polyether polyols (b3) and highly functional polyether polyols (b4) and also chain extenders and crosslinkers (b5).

The amine-started polyether polyols (b3) and highly functional polyetherols (b4) are obtainable in analogous manner to the polyether polyol (b1) by alkoxylation of a starter molecule. In the case of the amine-started polyether polyol (b3), preference is given to using ethylenediamine, tolylenediamine or mixtures thereof as starter molecules. In the context of the present invention, Mannich compounds are not considered to be amine-started polyols. The hydroxyl value of the amine-started polyether (b3) is preferably 200 to 850, more preferably 400 to 800, and in particular 500 to 800, mg KOH/g.

In the case of the highly functional polyether polyol (b4), the average (nominal) functionality is at least 5.0, preferably 5.5 to 8, more preferably 5.6 to 6.5. Starter molecules used are preferably sugar molecules, such as sucrose, more preferably in mixtures with glycerol. The hydroxyl value of the highly functional polyether (b4) is preferably at least 400, more preferably 400 to 900, and in particular 410 to 700 mg, KOH/g.

Alkylene oxides used for the preparation of the amine-started polyetherols (b3) and the highly functional polyetherols (b4) may be the alkylene oxides mentioned under (b1), individually or in mixtures. Preference is given to using ethylene oxide and/or 1,2-propylene oxide, especially exclusively 1,2-propylene oxide. The amine-started polyetherol (b3) and the highly functional polyetherol (b4) may likewise be prepared by a method analogous to that for the preparation of the polyetherol (b1).

Component (b) may further comprise chain extenders and/or crosslinkers (b5), for example for modifying the mechanical properties, for example hardness. Employed chain extenders and/or crosslinkers are diols and/or triols and also amino alcohols having molecular weights of less than 150 g/mol, preferably of 60 to 130 g/mol. Useful compounds include for example aliphatic, cycloaliphatic and/or araliphatic diols having 2 to 8, preferably 2 to 6, carbon atoms, for example ethylene glycol, 1,2-propylene glycol, diethylene glycol, dipropylene glycol, propane-1,3-diol, butane-1,4-diol, hexane-1,6-diol, o-, m-, and p-dihydroxycyclohexane, and bis(2-hydroxyethyl)hydroquinone. Likewise useful compounds are aliphatic and cycloaliphatic triols such as glycerol, trimethylolpropane, and 1,2,4- and 1,3,5-trihydroxycyclohexane.

Where chain extenders, crosslinkers or mixtures thereof are used for production of the rigid polyurethane foams, these are expediently used in an amount of 0% to 15% by weight, preferably 0% to 5% by weight, based on the total weight of component (b). Component (b) preferably comprises less than 2% by weight of chain extenders and/or crosslinkers (b5), more preferably less than 1% by weight, and in particular comprises none at all.

If the polyether polyol (b1) is here amine-started or has a functionality of 5.0 or greater, it is in the context of the present invention considered to be polyether polyol (b1) and not polyether polyol (b3) or polyether polyol (b4).

Component (b) preferably comprises 10% to 40% by weight, preferably 12% to 35% by weight, of the fatty-acid-based polyether polyol (b1), 20% to 65% by weight, preferably 25% to 65% by weight, more preferably 30% to 60% by weight, and in particular 40% to 60% by weight, of polyester polyol (b2), 0% to 20% by weight, preferably 5% to 15% by weight, of amine-started polyether polyol (b3), 0% to 30% by weight, preferably 5% to 25% by weight, of highly functional polyether polyol (b4), and 0% to 5% by weight of chain extenders and/or crosslinkers (b5), in each case based on the total weight of component (b).

Component (b) preferably comprises in addition to components (b1) to (b5) less than 20% by weight, more preferably less than 10% by weight, in each case based on the total weight of component (B), of further compounds having at least two hydrogen atoms reactive toward isocyanate groups, and in particular no such further compounds. The average functionality of component (B) is here preferably 3.0 to 6.0 and the hydroxyl value is 350 to 900 mg KOH/g.

The component (b) used according to the invention more preferably has an average hydroxyl value of 300 to 600 mg KOH/g, in particular 350 to 550 mg KOH/g. The hydroxyl value is determined in accordance with DIN 53240.

Generally employable as flame retardants (c) are the flame retardants known from the prior art.

Examples of suitable flame retardants are brominated esters, brominated ethers (Ixol) and brominated alcohols such as dibromoneopentyl alcohol, tribromoneopentyl alcohol, and 2-(2-hydroxyethoxy)ethyl 2-hydroxypropyl 3,4,5,6-tetrabromophthalate (PHT-4-Diol™), and also chlorinated phosphates, such as tris(2-chloroethyl) phosphate, tris(2-chloroisopropyl) phosphate (TCPP), tris(1,3-dichloropropyl) phosphate, tricresyl phosphate, tris(2,3-dibromopropyl) phosphate, tetrakis(2-chloroethyl) ethylenediphosphate, dimethyl methanephosphonate, diethyl diethanolaminomethylphosphonate, and also commercially available halogenated flame-retardant polyols. Other phosphates or phosphonates that may be employed as liquid flame retardants include diethyl ethanephosphonate (DEEP), triethyl phosphate (TEP), dimethyl propylphosphonate (DMPP), and diphenyl cresyl phosphate (DPC).

Aside from the abovementioned flame retardants, it is also possible to use inorganic or organic flame retardants such as red phosphorus, preparations comprising red phosphorus, aluminum oxide hydrate, antimony trioxide, arsenic oxide, ammonium polyphosphate and calcium sulfate, expandable graphite or cyanuric acid derivatives, for example melamine, or mixtures of at least two flame retardants, for example ammonium polyphosphates and melamine, and also optionally maize starch or ammonium polyphosphate, melamine, expandable graphite and optionally aromatic polyester polyols to render the rigid polyurethane foams flame-retardant.

Preference is given to using flame retardants that are liquid at room temperature. Particular preference is given to TCPP, TEP, DEEP, DMPP, DPC, PHT4-Diol™, brominated ethers, and tribromoneopentyl alcohol, especially TCPP, TEP, and PHT4-Diol™ and in particular TCPP. In a particularly preferred embodiment, the flame retardant (c) comprises a phosphorus-containing flame retardant and the content of phosphorus, based on the total weight of components (a) to (f), is preferably 0.9% to 1.5% by weight. The exclusive use of phosphorus-containing flame retardants as flame retardants is particularly preferable.

The proportion of the flame retardant (c) is generally 10% to 55% by weight, preferably 20% to 50% by weight, more preferably 25% to 35% by weight, based on the sum of components (b) to (f).

According to the invention, at least one blowing agent (d) is used. Blowing agents used for producing the rigid polyurethane foams include preferably water, formic acid, and mixtures thereof. These react with isocyanate groups to form carbon dioxide and in the case of formic acid to form carbon dioxide and carbon monoxide. These blowing agents are referred to as chemical blowing agents because they liberate gas through a chemical reaction with the isocyanate groups. In addition, it is possible to use physical blowing agents such as low-boiling hydrocarbons. Suitable materials are in particular liquids that are inert toward the isocyanates used and have boiling points below 100° C., preferably below 50° C., at atmospheric pressure, and which therefore evaporate under the influence of the exothermic polyaddition reaction. Examples of such liquids used with preference are aliphatic and cycloaliphatic hydrocarbons having 4 to 8 carbon atoms, such as heptane, hexane, and isopentane, preferably technical mixtures of n- and isopentanes, n- and isobutane and propane, cycloalkanes, such as cyclopentane and/or cyclohexane, ethers, such as furan, dimethyl ether, and diethyl ether, ketones, such as acetone and methyl ethyl ketone, alkyl carboxylates, such as methyl formate, dimethyl oxalate, and ethyl acetate, and halogenated hydrocarbons, such as methylene chloride, dichloromonofluoromethane, difluoromethane, trifluoromethane, difluoroethane, tetrafluoroethane, chlorodifluoroethanes, 1,1-dichloro-2,2,2-trifluoroethane, 2,2-dichloro-2-fluoroethane, and heptafluoropropane. It is also possible to use mixtures of these low-boiling-point liquids with one another and/or with other substituted or unsubstituted hydrocarbons. Examples of further suitable compounds are organic carboxylic acids such as formic acid, acetic acid, oxalic acid, ricinoleic acid and compounds containing carboxyl groups. Preferably, no halogenated hydrocarbons are used as blowing agents. Preference is given to using as chemical blowing agents water, formic acid-water mixtures or formic acid and particularly preferred chemical blowing agents are water or formic acid-water mixtures, especially exclusively water.

Preferably, the blowing agent (d) comprises, as a physical blowing agent, aliphatic or cycloaliphatic hydrocarbons having 4 to 8 carbon atoms, more preferably pentane isomers, or mixtures of pentane isomers. The chemical blowing agents can be used alone, i.e. without addition of physical blowing agents, or together with physical blowing agents. The chemical blowing agents are preferably used together with physical blowing agents, preference being given to using water or formic acid-water mixtures together with pentane isomers or mixtures of pentane isomers.

The amount used of the blowing agent or blowing agent mixture is generally 1% to 30% by weight, preferably 1.5% to 20% by weight, more preferably 2.0% to 15% by weight, in each case based on the sum of components (b) to (f). If water or a formic acid-water mixture serves as blowing agent, it is preferably added to component (b) in an amount of 0.2% to 6% by weight based on component (b). The water or formic acid-water mixture may be added in combination with the use of the other described blowing agents. Preference is given to using water or a formic acid-water mixture in combination with pentane.

The catalysts (e) used for producing the rigid polyurethane foams are in particular compounds that strongly accelerate the reaction with the polyisocyanates (a) of the compounds in components (b) that contain reactive hydrogen atoms, in particular hydroxyl groups.

It is expedient to use basic polyurethane catalysts, for example tertiary amines such as triethylamine, tributylamine, dimethylbenzylamine, dicyclohexylmethylamine, dimethylcyclohexylamine, N,N,N′,N′-tetramethyldiaminodiethyl ether, bis(dimethylaminopropyl)urea, N-methylmorpholine or N-ethylmorpholine, N-cyclohexylmorpholine, N,N,N′,N′-tetramethylethylenediamine, N,N,N,N-tetramethylbutanediamine, N,N,N,N-tetramethylhexane-1,6-diamine, pentamethyldiethylenetriamine, bis(2-dimethylaminoethyl) ether, dimethylpiperazine, N-dimethylaminoethylpiperidine, 1,2-dimethylimidazole, 1-azabicyclo[2.2.0]octane, 1,4-diazabicyclo[2.2.2]octane (Dabco) and alkanolamine compounds, such as triethanolamine, triisopropanolamine, N-methyldiethanolamine and N-ethyldiethanolamine, dimethylaminoethanol, 2-(N,N-dimethylaminoethoxy)ethanol, N,N′,N″-tris(dialkylaminoalkyl)hexahydrotriazines, for example N,N′,N″-tris(dimethylaminopropyl)-s-hexahydrotriazine, and triethylenediamine.

Further useful catalysts include: amidines, for example 2,3-dimethyl-3,4,5,6-tetrahydropyrimidine, tetraalkylammonium hydroxides, for example tetramethylammonium hydroxide, alkali metal hydroxides, for example sodium hydroxide, and alkali metal alkoxides, for example sodium methoxide and potassium isopropoxide, alkali metal carboxylates, and also alkali metal salts of long-chain fatty acids having 10 to 20 carbon atoms and optionally having pendant OH groups.

Likewise useful catalysts for the trimerization reaction of the NCO groups with one another include: catalysts that form isocyanurate groups, for example salts of ammonium ions or of alkali metals, especially ammonium carboxylates or alkali metal carboxylates, alone or in combination with tertiary amines. Isocyanurate formation results in greater crosslinking in the foam and to higher flame resistance than the urethane linkage.

Preference is given to using at least one basic polyurethane catalyst, preferably from the group comprising tertiary amines. Particular preference is given to using blowing catalysts such as bis(2-dimethylaminoethyl) ether, pentamethyldiethylenetriamine, 2-(N,N-dimethylaminoethoxy)ethanol or N,N,N-(trimethyl-N-hydroxyethyl(bis(aminoethyl) ether)). Most preferably, either bis(2-dimethylaminoethyl) ether or pentamethyldiethylenetriamine is used as sole amine-type polyurethane catalyst. Preferably, at least one catalyst from the group of trimerization catalysts is additionally used, preferably ammonium ion or alkali metal salts, more preferably ammonium or alkali metal carboxylates. Most preferably, either potassium acetate or potassium formate is used as sole trimerization catalyst.

Particular preference is given is given to using as catalyst (e) a catalyst mixture comprising tertiary amine as a polyurethane catalyst and a metal carboxylate or ammonium carboxylate as a trimerization catalyst.

The catalysts are expediently used in the smallest effective amount. The proportion of component (e) in the total amount of components (b) to (e) is preferably from 0.01% to 15% by weight, in particular from 0.05% to 10% by weight, especially from 0.1% to 5% by weight.

Further auxiliaries and/or additives (f) may optionally be added to the reaction mixture for producing the rigid polyurethane foams. Examples include foam stabilizers, surface-active substances, cell regulators, fillers, dyes, pigments, hydrolysis inhibitors, and fungistatic and bacteriostatic substances.

Employed silicone-containing foam stabilizers (F) used are silicone-based compounds that reduce the surface tension of the compounds having at least two hydrogen atoms reactive toward isocyanate groups (B). These substances are preferably compounds having an amphiphilic structure, i.e. where two parts of the molecule have different polarities. The silicone-based cell stabilizer preferably has one portion of the molecule comprising organosilicon units, such as dimethylsiloxane or methylphenylsiloxane, and one portion of the molecule having a chemical structure resembling the polyols from component (B). These are preferably polyoxyalkylene units. Employed silicone-containing cell stabilizers (F) used are preferably polysiloxane-polyoxyalkylene block copolymers having an oxyethylene content of greater than 20% by weight, more preferably greater than 75% by weight, based on the total proportion of polyoxyalkylene units. These preferably have polyethylene oxide and/or polypropylene oxide units. The molecular weight of the polyoxyalkylene side chains is preferably at least 1000 g/mol of side chains. These compounds are known and are described, for example, in “Kunststoffhandbuch” [Plastics handbook], volume 7, “Polyurethane” [Polyurethanes], Carl Hanser Verlag, 3rd edition 1993, chapter 3.4.4.2, and may be prepared for example by reaction of siloxane, for example polydimethylsiloxane, with polyoxyalkylenes, in particular polyethylene oxide, polypropylene oxide or copolymers of polyethylene oxide and polypropylene oxide. This makes it possible to obtain polysiloxane-polyoxyalkylene block copolymers that have the oxyalkylene chain as an end group or as one or more side chains. The silicone-containing foam stabilizers may have OH groups. Particular preference is given to using such substances as silicone-containing foam stabilizers, as described in EP 3619250.

The silicone-comprising foam stabilizer is preferably used in an amount of from 0.1% to 10% by weight, more preferably in amounts of from 0.5% to 5% by weight, and in particular in amounts of from 1-4% by weight, of silicone-comprising foam stabilizer, based on the total weight of components (b) to (f). Preference is here given to using in addition to the silicone-comprising foam stabilizer less than 20% by weight, particularly preferably less than 10% by weight, more preferably less than 5% by weight, of further compounds customarily used as foam stabilizers in polyurethanes, in particular no such further compounds. The amounts indicated are in each case based on the total weight of the silicone-comprising foam stabilizer and the further foam stabilizers.

Useful surface-active substances include for example compounds that support the homogenization of the input materials. Examples include emulsifiers, such as the sodium salts of castor oil sulfates or of fatty acids and salts of fatty acids with amines, for example diethylamine oleate, diethanolamine stearate, diethanolamine ricinoleate, salts of sulfonic acids, for example alkali metal or ammonium salts of dodecylbenzene- or dinaphthylmethanedisulfonic acid and ricinoleic acid; ethoxylated alkylphenols, ethoxylated fatty alcohols, paraffin oils, castor oil esters or ricinoleic esters, turkey red oil, and peanut oil, and cell regulators, such as paraffins, fatty alcohols, and dimethylpolysiloxanes. Other materials suitable for improving the emulsifying action, cell structure and/or stabilization of the foam are the oligomeric acrylates described above having polyoxyalkylene moieties and fluoroalkane moieties as pendant groups.

Fillers, in particular reinforcing fillers, are to be understood as meaning the customary organic and inorganic fillers, reinforcers, weighting agents, agents for improving abrasion behavior in paints, coating compositions, etc. that are known per se. Specific examples include: inorganic fillers such as siliceous minerals, for example sheet silicates, such as antigorite, serpentine, hornblendes, amphiboles, chrysotile, and talc, metal oxides, such as kaolin, aluminum oxides, titanium oxides, and iron oxides, metal salts, such as chalk, baryte, and inorganic pigments, such as cadmium sulfide and zinc sulfide, and also glass and the like. Preference is given to using kaolin (china clay), aluminum silicate, and coprecipitates of barium sulfate and aluminum silicate and also natural and synthetic fibrous minerals such as wollastonite, metal fibers, and in particular glass fibers of various lengths, which may optionally have been sized. Examples of useful organic fillers include: carbon, melamine, rosin, cyclopentadienyl resins, and graft polymers, and also cellulose fibers, polyamide fibers, polyacrylonitrile fibers, polyurethane fibers, and polyester fibers derived from aromatic and/or aliphatic dicarboxylic esters, and in particular carbon fibers.

The inorganic and organic fillers may be used either individually or as mixtures and are, if used, advantageously added to the reaction mixture in amounts of from 0.5% to 50% by weight, preferably from 1% to 40% by weight, based on the weight of components (b) to (f), although the content of mats and nonwoven and woven fabrics made of natural and synthetic fibers can reach values of up to 80% by weight based on the weight of components (b) to (f).

Further details about the abovementioned auxiliaries and additives (f) may be found in the technical literature, for example the monograph by J. H. Saunders and K. C. Frisch “High Polymers” volume XVI, Polyurethanes, parts 1 and 2, Verlag Interscience Publishers 1962 and 1964, or the Kunststoff-Handbuch [Plastics Handbook], Polyurethane [Polyurethanes], volume VII, Hanser-Verlag, Munich, Vienna, 1st and 2nd editions, 1966 and 1983 and 1993.

For the production of the rigid polyurethane foams, the polyisocyanates (a) and compounds (b), (d), (e), and, if present, (c) and (f), are reacted in such amounts that the isocyanate index is in a range between 90 and 180, preferably between 100 and 160, and more preferably between 105 and 150. The isocyanate index is the molar ratio of isocyanate groups to groups reactive toward isocyanate groups multiplied by 100.

The starting components are mixed at a temperature of from 15 to 90° C., preferably from 20 to 60° C., in particular from 20 to 45° C. The reaction mixture can be poured by means of high- or low-pressure metering machines into closed support tools. This technology is used to produce, for example, discontinuous sandwich elements.

Preference is given to using a polyol component (B) here. The polyol component (B) used for production of a rigid polyurethane foam is a premix of the components (b) of the invention, compounds having at least two hydrogen atoms reactive toward isocyanate groups, and (e), catalyst. To this premix may further be added, in full or in part, component (d), blowing agent, and, if present, (c), flame retardant, and (f) auxiliaries and additives. This facilitates the production of the rigid polyurethane foams of the invention, since fewer components have to be metered in to produce the reaction mixture.

The rigid foams of the invention are preferably produced on continuously operating double-belt plants. Here, the polyol component (B) and the isocyanate component (a) are metered in by means of a high-pressure machine and mixed in a mixing head. The compounds having at least two hydrogen atoms reactive toward isocyanate groups (b) may also be metered in beforehand with separate pumps, catalysts and/or blowing agents. The reaction mixture is applied continuously to the lower outer layer. The lower outer layer with the reaction mixture and the upper outer layer run into the double belt, in which the reaction mixture foams and cures. On exiting the double belt, the continuous sheet is cut to the desired dimensions. Sandwich elements having metallic outer layers or insulation elements having flexible outer layers can be produced in this way.

As lower and upper outer layers, which may be identical or different, it is possible to use flexible or rigid outer layers customarily employed in the double-belt process. These comprise outer layers made of metal such as aluminum or steel, outer layers made of bitumen, paper, nonwovens, plastic panels, for example polystyrene panels, plastic films, such as polyethylene films, or outer layers made of wood. The outer layers here may also be coated, for example with a conventional surface coating.

The rigid polyurethane foams produced by the process of the invention have a density of from 0.02 to 0.75 g/cm³, preferably from 0.025 to 0.24 g/cm³ and in particular from 0.03 to 0.1 g/cm³. They are particularly suitable as insulation material in the construction or refrigeration sector, for example as an intermediate layer for sandwich elements or for the insulation of refrigerators.

The rigid polyurethane foams of the invention feature particularly high flame resistance and therefore make it possible to use reduced amounts of flame retardants, in particular a reduced amount of toxic halogenated flame retardants. In a test in accordance with EN ISO 11925-2, the rigid foams of the invention preferably show a flame height of less than 15 cm, preferably less than 14 cm, and in particular less than 13.5 cm.

In addition, the rigid PUR foams of the invention meet all necessary requirements in respect of good processability and end-product properties even at low mold temperatures of <55° C. and without additional application of adhesion promoter: rapid foam curing, good adhesion of the foam to metallic outer layers, few defects on the foam surface, good compressive strengths, and good thermal insulation capability.

The rigid polyurethane foam obtained by the process of the invention features excellent mechanical properties, for example good compressive strengths, rapid foam curing, good adhesion of the foam to metallic outer layers, few defects on the foam surface, homogeneous fine-cell foaming, and good thermal insulation capability. In addition, a process of the invention leads to reaction mixtures that cure rapidly to rigid polyurethane foams without generating excessively high core temperatures, which means that the foams can be demolded faster or the pressure zone in the double belt can be shorter in design.

The present invention will be illustrated below with the aid of examples:

### EXAMPLES

The following input materials were used:
Polyetherol 1:

Preparation of a Fatty-Acid-Modified Polyether Alcohol:

A 6 L reactor was initially charged with 616.5 g of glycerol, 3.0 g of imidazole, 1037.6 g of sucrose, and 806.2 g of methyl oleate at 25° C. This was then inertized with nitrogen. The vessel was heated to 130° C. and 3505.4 g of propylene oxide was added. After a reaction time of 3 h, the reactor was evacuated for 60 minutes under full vacuum at 100° C. and then cooled to 25° C. The fatty-acid-modified polyether alcohol obtained had an OH value of 415 mg KOH/g.
Polyetherol 2: Polyether alcohol having a hydroxyl value of 750 mg KOH/g and a functionality of 4.0, based on propylene oxide and ethylenediamine as starter.
Polyetherol 3: Polyether alcohol having a hydroxyl value of 490 mg KOH/g and an average functionality of 4.3, based on propylene oxide and a mixture of sucrose and glycerol as starter.
Polyetherol 4: Polyether alcohol having a hydroxyl value of 400 mg KOH/g and a functionality of 3.0, based on propylene oxide and glycerol as starter.
Polyetherol 5: Polyether alcohol having a hydroxyl value of 430 mg KOH/g and a functionality of 5.9, based on propylene oxide and a mixture of sucrose and glycerol as starter.
Polyesterol 1: Polios NT 361, an aliphatic polyester from Purinova having a hydroxyl value of 350 mg KOH/g and a functionality of 3.1.
Polyesterol 2: Aromatic polyester having a hydroxyl value of 240 mg KOH/g and a functionality of 2.0, formed from phthalic anhydride and diethylene glycol.
Polyesterol 3: Isoexter 3061, an aromatic polyester from Coim having a hydroxyl value of 320 mg KOH/g and a functionality of 2.0.
Polyesterol 4: Terol 925, an aromatic polyester from Huntsman having a hydroxyl value of 305 mg KOH/g and a functionality of 2.45.
TCPP: Tris(2-chloroisopropyl) phosphate having a chlorine content of 32.5% by weight and a phosphorus content of 9.5% by weight.
Dabco® DC 193: Foam stabilizer from Evonik
Catalyst A: Trimerization catalyst consisting of 40% by weight of potassium formate dissolved in 54.0% by weight of monoethylene glycol and 6.0% by weight of mains water.
Catalyst B: Catalyst consisting of 23% by weight of bis(2-dimethylaminoethyl) ether and 77% by weight of dipropylene glycol.
Lupranat® M50: Polymeric methylenediphenyl diisocyanate (PMDI) having a viscosity of approx. 500 mPa·s at 25° C.
Pentane S 80/20: Mixture of 80% by weight of n-pentane and 20% by weight of isopentane.

Laboratory foaming for setting identical densities and setting times (gel times)

The phase-stable polyol components shown in Table 1 were produced from the abovementioned input materials. The polyol components were adjusted to identical setting times of 40 s±1 s and cup foam densities of 42 kg/m³±1 kg/m³ by varying the mains water and catalyst B. The amount of pentane and catalyst A was selected such that the finished foams of all settings comprised identical concentrations. The polyol components adjusted in this way were reacted with Lupranat® M50 in a mixing ratio such that the index for all settings was 145±5.

80 g of reaction mixture was reacted in this way in a paper cup by intensively mixing the mixture at 1500 rpm for 10 seconds using a laboratory stirrer from Vollrath.

TABLE 1
Polyol components

| | Example | | | | | |
|---|---|---|---|---|---|---|
| | 1 | 2 | 3 | 4 | 5 | 6 |
| | (inv.) | (comp.) | (comp.) | (comp.) | (inv.) | (inv.) |
| Polyetherol 1 | 15 | | 15 | 15 | 15 | 22 |
| Polyetherol 2 | 8.2 | 8.2 | 8.2 | 8.2 | 8.2 | |
| Polyetherol 3 | | 6.5 | | | | |
| Polyetherol 4 | | 8.5 | | | | |
| Polyetherol 5 | 12 | 12 | 12 | 12 | 12 | |
| Polyesterol 1 | 30 | 30 | | | | 43.2 |
| Polyesterol 2 | | | 30 | | | |
| Polyesterol 3 | | | | 30 | | |
| Polyesterol 4 | | | | | 30 | |
| TCPP | 32 | 32 | 32 | 32 | 32 | 32 |
| Dabco ® DC 193 | 1.8 | 1.8 | 1.8 | 1.8 | 1.8 | 1.8 |
| Water | 1 | 1 | 1 | 1 | 1 | 1 |

### Determination of Compressive Strengths

9 test specimens having dimensions of 50 mm×50 mm×50 mm were additionally taken from the same foam blocks for the determination of compressive strength according to DIN EN 844. Here too, the test specimens were always taken in the same way. Of the 9 test specimens, 3 test specimens were rotated such that the test was carried out counter to the rise direction of the foam (top). Of the 9 test specimens, 3 test specimens were rotated such that the test was carried out perpendicular to the rise direction of the foam (in the x-direction). Of the 9 test specimens, 3 test specimens were rotated such that the test was carried out perpendicular to the rise direction of the foam (in the y-direction). The average value of all the measurement results was then calculated, which is reported in Table 2 as “Compressive strength Ø”.

### Small Burner Test in Accordance with EN-ISO 11925-2

260 g of the reaction mixture set to identical reaction times and foam densities was stirred intensively for 10 seconds at 1500 rpm in a paper cup using a laboratory stirrer and transferred to a box mold having internal dimensions of 15 cm×25 cm×22 cm (length×width×height). 24 hours after curing of the reaction mixture, the resulting rigid foam block was demolded and shortened by 3 cm on all edges. The test specimens having dimensions of 190×90×20 mm were then conditioned for 24 hours at 20° C. and 65% humidity. 5 test specimens were taken from each rigid foam block and tested in accordance with DIN EN-ISO 11925-2 by applying a flame to the edge on the 90 mm side. The average value for the flame height is reported in Table 2 as “Ø flame height, EN-ISO 11925-2”.

### Determination of Foam Brittleness

The brittleness of the rigid foams was determined by pressing into the produced cup foams at the lateral upper edge with a comparable force 8 minutes after mixing the reaction components. The foam brittleness was assessed on the basis of a grading system according to the following criteria:
1. No brittleness: When pressing into the foam, no cracks in the foams are visible and no cracking sounds are perceptible.
2. Slight brittleness: When pressing into the foam, no cracks in the foams are visible but slight cracking sounds are perceptible.
3. Moderate brittleness: When pressing into the foam, fine cracks in the foams are visible and distinct cracking sounds can be perceived.
4. High brittleness: When pressing into the foam, distinct cracks in the foams including material chippings are visible and distinct cracking sounds can be perceived.

### Determination of Foam Surface Quality

To assess foam surface quality, transparent, flat-rolled TPU tubing having a width of 7.0 cm when flat and a diameter of 4.5 cm when opened was filled with reaction material. For filling with reaction material, approx. 100 cm of the tubing was unwound from a coil and the open end attached to a stand approx. 30 cm above the laboratory benchtop. A wide funnel in the open, upper end of the tubing opening was used to facilitate filling with the reaction material. A cable tie just below the funnel allowed an airtight seal to be made in the tubing immediately after filling with the reaction material. For the measurement, 100 g of reaction mixture set to identical reaction times and foam densities was mixed intensively in a paper cup for 7 seconds at 1500 rpm and immediately overturned into the tubing for 10 seconds. The open side of the tubing was then immediately closed with the cable tie, forcing the expanding foam to flow through the flat tubing toward the coil. Immediately after the reaction material had been overturned into the tubing, the cup with the residual reaction mixture was reweighed to determine the exact amount of reaction material present in the tubing. For evaluation of the foam surface qualities, only tubings containing an amount of reaction mixture of 65 g±5 g were used. After complete expansion and curing of the foam, the tubing was evenly truncated on both sides such that a 15 cm piece was taken directly from the middle of the tubing. The obtained foam middle piece was halved lengthwise and the two halves used to assess the surface quality and to measure cell sizes.

To evaluate the surface, a computer program was used to calculate the void area in relation to the total area and the surface quality assessed using the following grading system:
1. Very good surface quality (void area is 1-1.5% of the total area)
2. Good surface quality (void area is 1.5-2.0% of the total area)
3. Moderate surface quality (void area is 2.0-2.5% of the total area)
4. Poor surface quality (void area is 2.5-3.0% of the total area)
5. Very poor surface quality (void area is >3.0% of the total area)

### Cell Size

To determine the cell size, narrow slices were cut from the tubing halves plane-parallel to the halved cut surface and measured on the freshly cut side.

Before measuring, the cut surfaces were evenly sprayed with a carbon black spray from Goldlücke GmbH so as to cover the translucent foams with a light-impermeable layer, as a result of which the upper, cut cell webs stand out in high contrast against the underlying, unilluminated cell interiors when illuminated with a flat LED ring light.

The measurement was then carried out with a Pore!Scan microscope from Goldlücke GmbH on void-free areas of the contrasted foam.

After adjusting the magnification (with the aim of obtaining between 300 and 500 cells per image) and focusing the microscope, the measurement was performed. A computer software application automatically calculates the number of cells and cell diameters for each image. This measurement was in each case carried out at 5 different points per tubing middle piece. An average cell diameter distribution was then determined from the 5 measurements. The “Ø cell size” reported in Table 2 describes the sum of all measured cell diameters divided by the number of cells measured.

TABLE 2
Foam properties

| | Example | | | | | |
|---|---|---|---|---|---|---|
| | 1 | 2 | 3 | 4 | 5 | 6 |
| | (inv.) | (comp.) | (comp.) | (comp.) | (inv.) | (inv.) |
| Foam brittle- | 1 | 1 | 3 | 3 | 1 | 1 |
| ness [1-4] | | | | | | |
| Compressive | 0.20 | 0.18 | 0.20 | 0.20 | 0.19 | 0.19 |
| strength Ø | | | | | | |
| [MPa] | | | | | | |
| Foam surface | 1 | 5 | 4 | 4 | 2 | 2 |
| quality [1-6] | | | | | | |
| Ø Cell size | 280 | 308 | 327 | 335 | 290 | 291 |
| [μm] | | | | | | |
| Ø Flame | 14.4 | 15.3 | 15.0 | 15.8 | 11.1 | 10.5 |
| height, DIN | | | | | | |
| EN-ISO | | | | | | |
| 11925-2 [cm] | | | | | | |

The combination of the polyether polyols 3 and 4 in comparative example 2 results on average in an identical functionality and OH value as in the polyether polyol 1 from example 1, example 5, and example 6. Surprisingly, it was found that the foams from comparative example 2 have a significantly worse foam surface than the foams from example 1, example 5, and example 6. The cell size measurement gives rise also to a larger cell diameter, which from experience, together with the poorer foam surface, has a negative effect on the thermal insulation effect of the foams. In addition, the foams from comparative example 2 surprisingly result in markedly higher flame peaks in the test according to DIN EN ISO 11925-2, which led to failure of the test, since the average flame height exceeds the 15 cm mark. By comparison with the foams from example 1, example 5, and example 6, the foams from comparative example 2 also have a lower compressive strength.

Replacing the crosslinking polyester polyols (polyesterol 1 and polyesterol 4) with polyesterol 2 (comparative example 3) and polyesterol 3 (comparative example 4) having a lower OH value and/or functionality surprisingly results, despite the identical index of the produced foams, in markedly poorer fire resistance and likewise led to failure of the test according to DIN EN-ISO 11925-2. In addition, the foams from comparative example 3 and comparative example 4 have poorer surface quality and an increased average cell size compared to the foams from example 1, example 5, and example 6.

Moreover, the foams from comparative example 3 and comparative example 4 have increased foam brittleness compared to the foams from example 1, example 5, and example 6. The increased brittleness at the surface is disadvantageous, since experience has shown this to result in poorer adhesion of foams to outer layer materials.

Only the combination of input materials described in examples example 1, example 5, and example 6 makes it possible to produce reaction mixtures meeting all requirements.

1. A process for producing rigid polyurethane foams, comprising:
mixing
a) polyisocyanates
b) compounds having at least two hydrogen atoms reactive toward isocyanate groups,
c) optionally flame retardants,
d) blowing agent,
e) catalyst, and
f) optionally auxiliaries and additives
to give a reaction mixture and curing the reaction mixture to form a rigid polyurethane foam,
wherein the component (b) comprises
(b1) at least one polyether polyol prepared by reaction of
(b11) 15% to 40% by weight, based on the total weight of the polyether polyol (b1), of one or more polyols or polyamines having an average functionality of 2.5 to 8,
(b12) 2% to 30% by weight, based on the total weight of the polyether polyol (b1), of one or more fatty acids and/or fatty acid monoesters, and
(b13) 35% to 70% by weight, based on the total weight of the polyether polyol (b1), of propylene oxide,
and
(b2) at least 20% by weight, based on the total weight of component (b), of a polyester polyol having an average functionality of ≥2.4 and an OH value of ≥280 mg KOH/g and optionally
(b3) one or more amine-started polyether polyols,
(b4) one or more highly functional polyether polyols having an average functionality of at least 5.0, and
(b5) one or more chain extenders and/or crosslinkers,
and
component (b) in addition to components (b1) to (b5) comprises less than 20% by weight, based on the total weight of component (b), of further compounds having at least two hydrogen atoms reactive toward isocyanate groups.

2. The process as claimed in claim 1, wherein, for the production of polyether polyol (b1), a mixture of glycerol and sucrose is used as polyol (b11).

3. The process as claimed in claim 1, wherein the polyester polyol (b2) includes at least one aromatic polyester polyol (b2a) having a functionality of 2.4 to 3.0 and an OH value of 280 to 330 mg KOH/g.

4. The process as claimed in claim 1, wherein the polyester polyol (b2) includes at least one aliphatic polyester polyol (b2b) having a functionality of greater than 2.8 to 3.4 and an OH value of 300 to 400 mg KOH/g.

5. The process as claimed in claim 1, wherein the polyester polyol (b2), based on the total weight thereof, comprises ≤5% by weight of fatty acid moieties.

6. The process as claimed in claim 1, wherein component (b) comprises at least one polyether polyol (b3) prepared by alkoxylation of ethylenediamine, tolylenediamine or mixtures thereof.

7. The process as claimed in claim 1, wherein component (b) comprises at least one polyether polyol (b4) having an average functionality of ≥5.0 and an OH value of ≥400 mg KOH/g.

8. The process as claimed in claim 1, wherein component (b) comprises 10% to 40% by weight of polyether polyol (b1), 20% to 65% by weight of polyester polyol (b2), 0% to 20% by weight of amine-started polyether polyol (b3), and 0% to 30% by weight of polyether polyol (b4), in each case based on the total weight of component (b).

9. The process as claimed in claim 1, wherein the isocyanate index is 100 to 160.

10. The process as claimed in claim 1, wherein the blowing agent (d) comprises at least one aliphatic or cycloaliphatic hydrocarbon having 4 to 8 carbon atoms.

11. The process as claimed in claim 1, wherein the catalyst (e) is a catalyst mixture comprising tertiary amine and metal carboxylate or ammonium carboxylate.

12. The process as claimed in claim 1, wherein the flame retardants (c) comprise a phosphorus-containing flame retardant and that the content of phosphorus, based on the total weight of the components (a) to (f), is 0.9% to 1.5% by weight.

13. The process as claimed in claim 1, wherein the process is a process for producing sandwich elements and is carried out in a double belt.

14. A rigid polyurethane foam obtainable by a process as claimed in claim 1.

15. A polyol component for producing a rigid polyurethane foam comprising (b) compounds having at least two hydrogen atoms reactive toward isocyanate groups, (c) optionally flame retardant, (d) optionally blowing agent, (e) catalyst, and (f) optionally auxiliaries and additives,
wherein component (b) comprises at least one polyether polyol (b1) and an aromatic polyester polyol (b2) and the polyether polyol (b1) can be produced by reacting
15% to 40% by weight, based on the total weight of the polyether polyol (b1), of one or more polyols or polyamines (b11) having an average functionality of 2.5 to 8,
2% to 30% by weight, based on the total weight of the polyether polyol (b1), of one or more fatty acids and/or fatty acid monoesters (b12), and
35% to 70% by weight, based on the total weight of the polyether polyol (b1), of propylene oxide (b13),
and wherein component (b) comprises at least 20% by weight, based on the total weight of component (b), of polyester polyol (b2) having an average functionality of 2.4 or greater and an OH value of 280 mg KOH/g or more,
and wherein component (b) optionally comprises
(b3) amine-started polyether polyols,
(b4) highly functional polyether polyols having an average functionality of at least 5.0, and
(b5) chain extenders and crosslinkers,
and
component (b) in addition to components (b1) to (b5) comprises less than 20% by weight, based on the total weight of component (b), of further compounds having at least two hydrogen atoms reactive toward isocyanate groups.
